(19) United States
(12) Patent Application Publication
(10) Pub. No.: US 2026/0113709 A1
(43) Pub. Date: Apr. 23, 2026

(54) COMMUNICATION SYSTEM

(71) Applicant: DENSO CORPORATION, Kariya-city (JP)

(72) Inventors: Yoji HOMMA, Kariya-city (JP); Tomohisa KISHIGAMI, Kariya-city (JP)

(21) Appl. No.: 19/357,209

(22) Filed: Oct. 14, 2025

(30) Foreign Application Priority Data
Oct. 17, 2024 (JP) 2024-181920

(51) Int. Cl. H04W 52/02

(52) U.S. Cl. CPC H04W 52/0235

(57) ABSTRACT

A communication system includes a first communication device, one or more second communication devices, and one or more third communication devices, which are connected in a hierarchal structure. The first communication device includes a first transceiver, the one or more second communication devices include a second transceiver, and the one or more third communication devices include a third transceiver. Each transceiver is configured to detect a wake-up signal and activate the corresponding communication device from a sleep state to a wake-up state according to the detected wake-up signal. The first transceiver and/or the second transceiver is configured to transmit, in response to detection of wake-up signal, the wake-up signal to a communication line different from the communication line on which the wake-up signal is detected while maintaining the sleep state.

### CROSS REFERENCE TO RELATED APPLICATION

The present application claims the benefit of priority from Japanese Patent Application No. 2024-181920 filed on October 17, 2024. The entire disclosure of the above application is incorporated herein by reference.

### TECHNICAL FIELD

The present disclosure relates to a communication system.

### BACKGROUND

Conventionally, a communication system includes multiple communication devices communicating with one another via a communication line. Each communication device has, as operation modes, a wake-up mode and a sleep mode. The wake-up mode is a normal operation mode in which all functions assigned to the communication device in advance can be used. The sleep mode is an operation mode in which some functions are restricted in order to reduce power consumption.

### SUMMARY

According to an aspect of the present disclosure, a communication system includes a first communication device, one or more second communication devices connected to a communication line to directly communicate with the first communication device, one or more third communication devices connected to a communication line to directly communicate with the first communication device or the one or more second communication devices. The first communication device includes a first transceiver, the one or more second communication devices include a second transceiver, and the one or more third communication devices include a third transceiver. Each of the communication devices has a wake-up state, which is a normal operating state, and a sleep state, which is a low-power operating state in which a power consumption is lowered compared with the normal operating state by partially or completely restricting functions other than a function of transceiver. Each of the first transceiver, the second transceiver, and the third transceiver may include a detection unit configured to detect a wake-up signal, which is a signal instructing the corresponding communication device to transition to the wake-up state, and an activation unit configured to activate the corresponding communication device from the sleep state to the wake-up state when the wake-up signal is detected by the detection unit. The first transceiver and/or the second transceiver includes a transfer unit configured to transmit, in response to the detection unit detecting the wake-up signal, the wake-up signal to one of the communication lines different from the communication line on which the wake-up signal is detected while maintaining the sleep state of the corresponding communication device.

### BRIEF DESCRIPTION OF DRAWINGS

Features of the present disclosure will become apparent from the following detailed description made with reference to the accompanying drawings. In the drawings:

FIG. 1 is a block diagram showing a first layer and a second layer in a configuration of a communication system;

FIG. 2 is a block diagram showing a third layer in the configuration of the communication system;

FIG. 3 is a flowchart of an advance wake-up process;

FIG. 4 is a schematic diagram showing a configuration of a communication system according to a first modification example; and

FIG. 5 is a block diagram showing a first layer and a second layer in a configuration of a communication system according to a second modification example.

### DETAILED DESCRIPTION

In recent years, in a communication system, multiple communication devices are connected in a hierarchical structure. As a result of detailed investigation by the inventors of the present disclosure into such a communication system, the following difficulties are found. When each communication device transitions from a sleep mode to a wake-up mode, in a configuration where the multiple communication devices are connected to form a hierarchical structure, each communication device must transition to the wake-up mode in stages and layer by layer, and it takes a long time from when the communication device belonging to the first layer transitions to the wake-up mode until the communication device belonging to the final layer transitions to the wake-up mode.

According to an aspect of the present disclosure, a communication system includes a first communication device, one or more second communication devices connected to a communication line to directly communicate with the first communication device, one or more third communication devices connected to a communication line to directly communicate with the first communication device or the one or more second communication devices. The first communication device includes a first transceiver, the one or more second communication devices include a second transceiver, and the one or more third communication devices include a third transceiver. Each of the communication devices has a wake-up state, which is a normal operating state, and a sleep state, which is a low-power operating state in which a power consumption is lowered compared with the normal operating state by partially or completely restricting functions other than a function of transceiver. Each of the first transceiver, the second transceiver, and the third transceiver includes a detection unit configured to detect a wake-up signal, which is a signal instructing the corresponding communication device to transition to the wake-up state, and an activation unit configured to activate the corresponding communication device from the sleep state to the wake-up state when the wake-up signal is detected by the detection unit. The first transceiver and/or the second transceiver includes a transfer unit configured to transmit, in response to the detection unit detecting the wake-up signal, the wake-up signal to one of the communication lines different from the communication line on which the wake-up signal is detected while maintaining the sleep state of the corresponding communication device.

In the above configuration, although the communication system includes the multiple communication devices connected in a hierarchical structure, it is possible to suppress an increase of time required for the multiple communication devices to wake up sequentially layer by layer. For example, when the transition to the wake-up state is performed in the order of a first hierarchical level to which a first communication device belongs, a second hierarchical level to which one or more second communication devices belong, and a third hierarchical level to which one or more third communication devices belong, it is possible to suppress the time required for the communication devices to wake up in the communication system by providing the transfer unit, compared to a communication system that does not include a transfer unit. The second communication device can transmit the wake-up signal to the third communication device while maintaining the sleep state. That is, while the second communication device transitions to the wake-up state, the third communication device also transitions to the wake-up state. Therefore, the time required for nodes in all layers to transition to the wake-up state can be shortened. Thus, in the communication system including the multiple communication devices connected in a hierarchical structure, it is possible to suppress an increase in the time required for the multiple communication devices sequentially wake up layer by layer.

The following will describe embodiments of the present disclosure with reference to the drawings.

### (1. Embodiment)

### (1-1. Configuration)

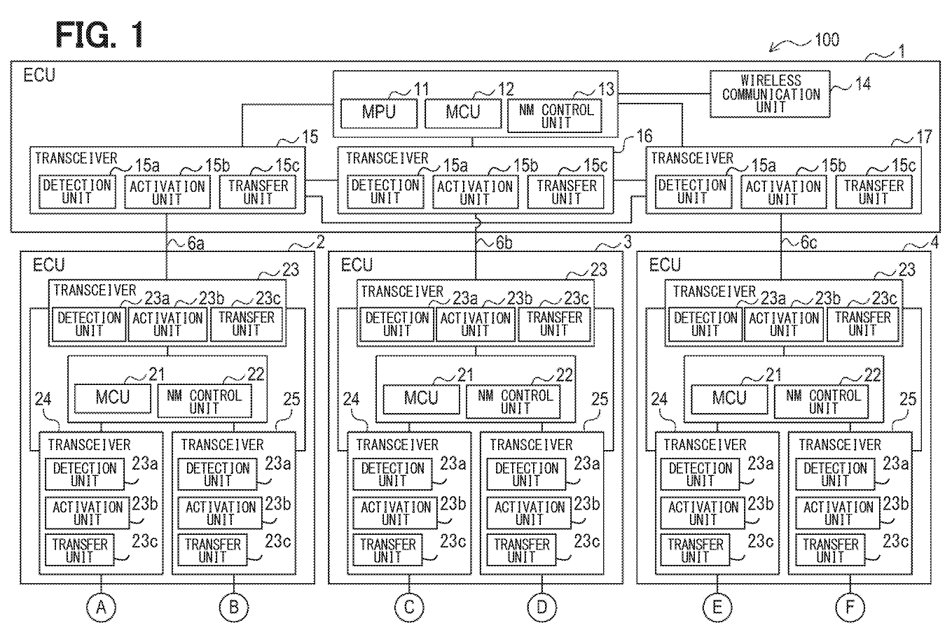

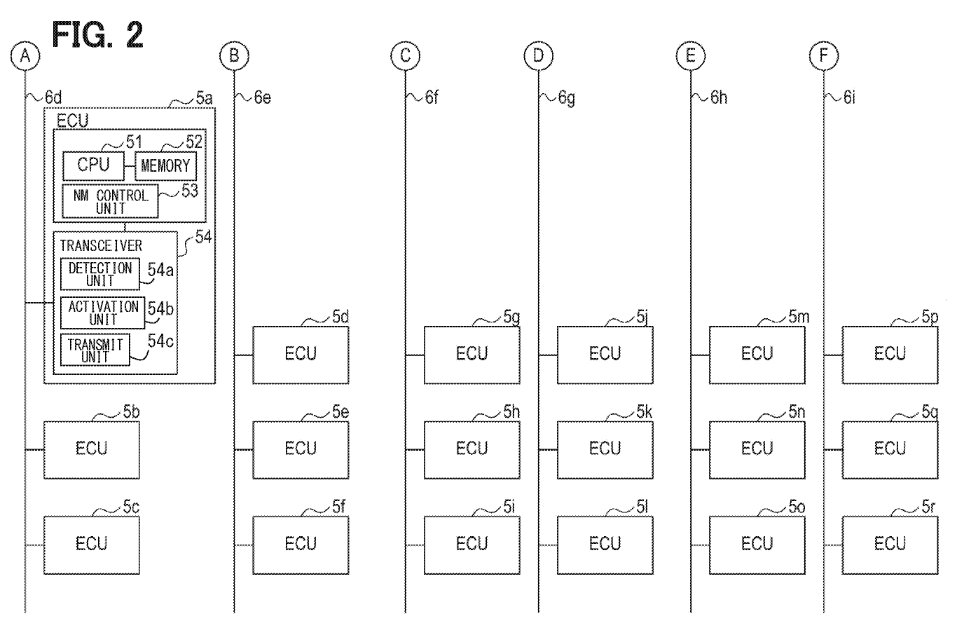

A communication system 100 shown in FIG. 1 and FIG. 2 constitutes an in-vehicle network system mounted on a vehicle, such as a passenger car. The communication system 100 includes a central ECU 1, multiple zone ECUs 2, 3, 4, and multiple terminal ECUs 5a, 5b, 5c, 5d, 5e, 5f, 5g, 5h, 5i, 5j, 5k, 5l, 5m, 5n, 5o, 5p, 5q, 5r. ECU is an abbreviation for Electronic Control Unit. Hereinafter, the central ECU 1, the multiple zone ECUs 2 to 4, and the multiple terminal ECUs 5a to 5r may be referred to as nodes.

A node is a communication device equipped with a communication function. The central ECU 1 controls the multiple zone ECUs 2 to 4, thereby performing coordinated control of the entire vehicle. The central ECU 1 is connected to communication lines 6a to 6c and is able to directly communicate with the multiple zone ECUs 2 to 4. Herein, “be able to directly communicate” means be able to transmit and receive data without going through a relay device. The central ECU 1 is connected to the multiple zone ECUs 2 to 4 via individual communication lines 6a to 6c, respectively. The central ECU 1 and the multiple zone ECUs 2 to 4 are connected via a first network. The first network may be, for example, an Ethernet. Ethernet is a registered trademark.

The zone ECUs 2 to 4 are respectively provided for multiple zones. An area in which the communication system 100 is installed are divided into the multiple zones. The zone ECUs 2 to 4 are respectively provided for multiple zones, into which the internal area of vehicle is divided. Each of the multiple zone ECUs 2 to 4 mainly controls the multiple terminal ECUs 5a to 5r that are located in the corresponding zone. Each of the multiple zone ECUs 2 to 4 is connected to the multiple terminal ECUs 5a to 5r located in the corresponding zone via an individual communication line 6d to 6i. In other words, the terminal ECUs 5a to 5r are connected to the communication lines 6d to 6i so as to be able to directly communicate with the corresponding zone ECU 2 to 4. Among the multiple terminal ECUs 5a to 5r, terminal ECUs connected to different communication lines are able to indirectly communicate with one another. Herein, "being able to communicate indirectly" means that frames can be transmitted and received via at least one relay device. The central ECU 1 and the multiple zone ECUs 2 to 4 also function as relay devices for relaying frames. For example, the terminal ECU 5a connected to the communication line 6d and the terminal ECU 5d connected to the communication line 6e can transmit and receive frames with one another via the zone ECU 2 as a relay device. For example, the terminal ECU 5g connected to the communication line 6f and the terminal ECU 5p connected to the communication line 6i can transmit and receive frames with one another via the zone ECU 3, the central ECU 1, and the zone ECU 4, as relay devices.

The zone ECUs 2 to 4 are connected to the subordinate terminal ECUs 5a to 5r via a second network. The second network may be provided by CAN. CAN is an abbreviation for Controller Area Network.

The first network and the second network are not limited to Ethernet or CAN, and a different network using different communication protocol may be used as the first network or the second network. An optional communication protocol may be LIN, FlexRay (registered trademark), MOST (registered trademark), or CXPI (registered trademark). LIN is an abbreviation for Local Interconnect Network. MOST is an abbreviation for Media Oriented Systems Transport. CXPI is an abbreviation for Clock Extension Peripheral Interface.

As described above, in the communication system 100, the nodes are connected to in a hierarchical structure. The hierarchy to which the central ECU 1 belongs is referred to as the first hierarchy, the hierarchy to which the multiple zone ECUs 2 to 4 belong is referred to as the second hierarchy, and the hierarchy to which the multiple terminal ECUs 5a to 5r belong is referred to as the third hierarchy.

A node can switch between a wake-up state and a sleep state. The wake-up state is a normal operating state in which all functions assigned to the node can be used. The sleep state is a low power consumption state in which at least a part of the functions is limited. More specifically, the sleep state is a low-power operation state in which some or all of the functions except the function of node transceiver are restricted. The low-power operation state is also referred to as a power saving operation state.

Each of the central ECU 1 and the multiple zone ECUs 2 to 4 has an advance wake-up function. The advance wake-up function is a function that a node transmits a signal to wake up other nodes in the sleep state of own node. In response to receiving a signal instructing the node to switch to the wake-up state, the node transmits a signal to wake up other nodes before the node itself switches from the sleep state to the wake-up state. The advance wake-up function is executed when each of the central ECU 1 and the multiple zone ECUs 2 to 4 acts as relay device and relays an NM frame, which will be described later. NM is abbreviation for network management.

### (1-1-1. Central ECU)

The central ECU 1 includes an MPU 11, an MCU 12, a wireless communication unit 14, and first transceivers 15 to 17. MPU is an abbreviation for Micro Processing Unit. MCU is an abbreviation for Micro Control Unit. The sleep state of the central ECU 1 includes a state in which power supply to the MPU 11 and the MCU 12 is deactivated, and a state in which power supply to the MPU 11 and the MCU 12 is activated but the transition to the wake-up state is not yet completed (that is, a state in which the transition to the wake-up state is in progress). In the sleep state, the functions of first transceivers 15 to 17 and the functions of wireless communication unit 14 are available.

The MPU 11 and the MCU 12 each includes a CPU and a semiconductor memory (hereinafter referred to as memory) such as a ROM or a RAM. The memory stores programs that control the CPU to execute predetermined functions.

The central ECU 1 implements a function of NM control unit 13 by executing the program stored in the memory using the CPU. The NM control unit 13 is configured to generate an NM frame. The NM frame is a frame for managing a state of the communication system 100. For example, the NM frame includes a first frame indicating that the transceiver of own node is available for use, and a second frame instructing another node to transition to a wake-up state.

In the present embodiment, the nodes included in the communication system 100 are classified into multiple groups in advance. Each group includes one or more nodes necessary to provide one service. For example, the group in which the nodes necessary to implement a car finder service is included is referred to as the first group. The group in which the nodes necessary to implement a monitoring service is included is referred to as the second group. The group in which the nodes necessary to implement a key service is included is referred to as the third group. The car finder service, the monitoring service, and the key service will be described later. The number of groups may be set to one or more. Each group may include one or more nodes. For each service, one or more groups may be defined corresponding to the service. The term "service" may refer to a specific function or may be a general term for a group of services executed in parking state or in driving state.

The second frame is generated by associating the bit positions of data fields with the groups. For example, a rule is set in advance such that the most significant bit of data field is assigned to the first group, and when the most significant bit of data field is "1", the node included in the first group is controlled to transition to the wake-up state.

The NM control unit 13 generates the second frame according to a predetermined rule. Each node determines whether to wake up or not when it receives the second frame according to the predetermined rule. To implement each service, the nodes belonging to each group must be waked up, and each node transitions to the wake-up state according to the rule.

The wireless communication unit 14 is a transceiver configured to perform wireless communication with a communication device outside the vehicle. For example, the wireless communication unit 14 is configured to receive an event from the cloud.

The first transceiver 15 is connected to a second transceiver 23 of the zone ECU 2 via the communication line 6a. The first transceiver 16 is connected to a second transceiver 23 of the zone ECU 3 via the communication line 6b. The first transceiver 17 is connected to a second transceiver 23 of the zone ECU 4 via the communication line 6c.

The first transceivers 15 to 17 are configured to be able to process NM frames. Being able to process NM frames means having the function to receive NM frame and read data of NM frame. The first transceivers 15 to 17 each includes a detection unit 15a, an activation unit 15b, and a transfer unit 15c. The functions of the first transceivers 15 to 17 are implemented by hardware circuits. A circuit refers to one or more hardware logic circuits that are configured to perform a specific process defined based on a pre-designed circuit configuration. In other words, a circuit refers to a hardware device that executes specific processing based on the circuit configuration, rather than processing defined by software such as computer program code. For example, the circuitry may include custom ICs such as ASICs and FPGAs designed using a hardware description language. That is, the circuitry includes all hardware circuits except for a processor that executes processing by reading computer program code. ASIC is an abbreviation for Application Specific Integrated Circuit. FPGA is an abbreviation for Field Programmable Gate Array.

The detection unit 15a is configured to detect a wake-up signal. The wake-up signal is a signal that instructs a node to transition to a wake-up state. In the present embodiment, an NM frame generated by another node is used as the wake-up signal. More specifically, as the wake-up signal, the second frame generated by another node is used.

For example, the detection unit 15a determines that a wake-up signal is detected when, in the data field, the bit position corresponding to the group in which own node is included is "1". The activation unit 15b is configured to switch the node from the sleep state to the wake-up state when the detection unit 15a detects a wake-up signal. When the detection unit 15a detects a wake-up signal, the activation unit 15b controls the MPU 11 and the MCU 12 to restart the power supply.

When the detection unit 15a detects a wake-up signal, the transfer unit 15c is configured to transmit the wake-up signal to a communication line different from the communication line on which the wake-up signal is detected while maintaining the sleep state. That is, the transfer unit 15c transfers the second frame, which is detected as a wake-up signal by the detection unit 15a, without changing the second frame.

The transfer unit 15c is configured to transmit the wake-up signal to a predetermined communication line depending on the communication line through which the wake-up signal is received. Specifically, a receiving bus, which is a communication line for receiving a wake-up signal, is associated with a transmitting bus, which is a communication line for transmitting a wake-up signal, in advance. The transfer unit 15c transfers the wake-up signal in accordance with the preset association. For example, when the receiving bus is the communication line 6a, the transmitting bus is set as the communication line 6c. For another example, when the receiving bus is the communication line 6b, the transmitting bus is set as the communication line 6a and the communication line 6c. The process in which the transfer unit 15c determines the communication line to which the wake-up signal is to be transferred and transfers the wake-up signal is also referred to as a routing processing.

When the detection unit 15a detects a wake-up signal, the activation unit 15b activates the own node to transitions to the wake-up state, and the transfer unit 15c transfers the wake-up signal. That is, when the detection unit 15a detects a wake-up signal, the first transceivers 15 to 17 almost simultaneously execute a process for restarting the power supply to the MPU 11 and the MCU 12 and a process of transferring the wake-up signal. When the power supply is restarted, the MPU 11 and the MCU 12 execute processes required for the node to transition to the wake-up state, such as executing an initial sequence. Therefore, it takes time for the MPU 11 and the MCU 12 to complete the transition to the wake-up state after the power supply is started. On the other hand, the processing of the transfer unit 15c is implemented by the hardware circuit and does not take much time because the transfer unit 15c only needs to transfer the wake-up signal to a predetermined communication line. Therefore, even when the processing of activation unit 15b is executed simultaneously with the processing of transfer unit 15c, the wake-up signal can be transferred by the transfer unit 15c prior to a completion of the transition to the wake-up state executed by the activation unit 15b.

### (1-1-2. Zone ECU)

The zone ECUs 2 to 4 each includes an MCU 21 and second transceivers 23, 24, 25. The sleep state in zone ECU 2 to 4 includes a state in which power supply to the MCU 21 is deactivated, and a state in which power supply to the MCU 21 is started but the transition to the wake-up state is not yet completed (that is, a state in which the transition to the wake-up state is in progress). Even in the sleep state, the functions of the second transceivers 23 to 25 are available.

The MCU 21 includes a CPU and a memory. The memory stores programs that control the CPU to execute predetermined functions. Each zone ECU 2 to 4 implements a function of NM control unit 22 by executing the program stored in the memory using the CPU. The NM control unit 22 is configured to generate an NM frame, similar to the NM control unit 13 of the central ECU 1.

The second transceiver 23 of the zone ECU 2 is connected to the first transceiver 15 of the central ECU 1 via the communication line 6a. The second transceiver 24 of the zone ECU 2 is connected to a third transceivers 54 of the terminal ECU 5a, 5b, 5c via a communication line 6d.

The second transceiver 25 of the zone ECU 2 is connected to a third transceivers 54 of the terminal ECU 5d, 5e, 5f via a communication line 6e. The second transceiver 23 of the zone ECU 3 is connected to the first transceiver 16 of the central ECU 1 via the communication line 6b.

The second transceiver 24 of the zone ECU 3 is connected to a third transceivers 54 of the terminal ECUs 5g, 5h, 5i via a communication line 6f. The second transceiver 25 of the zone ECU 3 is connected to a third transceivers 54 of the terminal ECUs 5j, 5k, 5l via a communication line 6g.

The second transceiver 23 of the zone ECU 4 is connected to the first transceiver 17 of the central ECU 1 via the communication line 6c. The second transceiver 24 of the zone ECU 4 is connected to a third transceivers 54 of the terminal ECUs 5m, 5n, 5o via a communication line 6h.

The second transceiver 25 of the zone ECU 4 is connected to a third transceivers 54 of the terminal ECUs 5p, 5q, 5r via a communication line 6i. The second transceivers 23 to 25 are configured to be able to process NM frames. The second transceivers 23 to 25 each includes a detection unit 23a, an activation unit 23b, and a transfer unit 23c. The functions of the second transceivers 23 to 25 are implemented by hardware circuits, similar to the functions of the first transceivers 15 to 17.

Each detection unit 23a is configured to detect a wake-up signal. Each activation unit 23b is configured to switch own node from the sleep state to the wake-up state when a wake-up signal is detected by each detection unit 23a. More specifically, when a wake-up signal is detected by each detection unit 23a, each activation unit 23b controls the MCU 21 to restart the power supply.

When a wake-up signal is detected by each detection unit 23a, each transfer unit 23c is configured to transmit the wake-up signal to a communication line different from the communication line on which the wake-up signal is detected while maintaining the sleep state. Each transfer unit 23c is set so that a receiving bus is associated with a transmitting bus in advance. For example, when the receiving bus is communication line 6a, the transmitting bus is set to communication line 6d and communication line 6e. As another example, when the receiving bus is communication line 6e, the transmitting bus is set to communication line 6d.

Each transfer unit 23c also performs protocol conversion processing to convert Ethernet frames into CAN frames and convert CAN frames into Ethernet frames. When a protocol of NM frame detected by the detection unit 23a is converted to another protocol and transferred by the transfer unit 23c, the detected NM frame and the transferred NM frame may be treated as the same frame. The wake-up signal transmitted by the transfer unit 23c may be considered to be the same as the NM frame detected by the detection unit 23a, rather than an NM frame newly generated by the transfer unit 23c.

When the detection unit 23a detects a wake-up signal, the activation unit 23b activates the own node to transitions to the wake-up state, and the transfer unit 23c transfers the wake-up signal. That is, when the detection unit 23a detects a wake-up signal, the second transceivers 23 to 25 almost simultaneously execute a process for restarting the power supply to the MCU 21 and a process of transferring the wake-up signal. When the power supply is restarted, the MCU 21 executes a process required for the node to transition to the wake-up state, such as executing an initial sequence. Therefore, it takes time for the MCU 21 to complete the transition to the wake-up state after the power supply is started. On the other hand, the processing of the transfer unit 23c is implemented by the hardware circuit and does not take much time because the transfer unit 23c only needs to transfer the wake-up signal to a predetermined communication line. Therefore, even when the processing of activation unit 23b is executed simultaneously with the processing of transfer unit 23c, the wake-up signal can be transferred by the transfer unit 23c prior to a completion of the transition to the wake-up state executed by the activation unit 23b.

### (1-1-3. Terminal ECU)

Each of the terminal ECUs 5a to 5r includes a CPU 51, a memory 52, and a third transceiver 54. The sleep state of terminal ECU 5a to 5r includes a state in which power supply to the CPU 51 is deactivated. Even in the sleep state, the functions provided by the third transceiver 54 are available.

The memory 52 stores programs to be executed by the CPU 51 to perform predetermined functions. The terminal ECU 5 a to 5r implements a function of NM control unit 53 by executing the program stored in the memory 52 using the CPU 51. The NM control unit 53 is configured to generate an NM frame, similar to the NM control unit 13 of the central ECU 1.

The third transceiver 54 of the terminal ECU 5a is connected to the second transceiver 24 of the zone ECU 2 via the communication line 6d. The third transceiver 54 of the terminal ECU 5a can also directly communicate with the terminal ECUs 5b and 5c connected to the communication line 6d. Detailed description of the communication lines to which the terminal ECUs 5b to 5r are connected will be omitted.

The third transceiver 54 is configured to be able to process NM frames. The third transceiver 54 includes a detection unit 54a, an activation unit 54b, and a transmitting unit 54c. The functions of the third transceiver 54 are implemented by hardware circuits, similar to the first transceivers 15 to 17.

Each detection unit 54a is configured to detect a wake-up signal. Each activation unit 54b is configured to switch own node from a sleep state to a wake-up state when a wake-up signal is detected by each detection unit 54a. More specifically, when a wake-up signal is detected by each detection unit 54a, each activation unit 54b performs a control to restart power supply to the CPU 51.

Each transmitting unit 54c is configured to transmit a frame. Each transmitting unit 54c is configured to transmit at least the NM frame generated by the NM control unit 53.

### (1-2. Process)

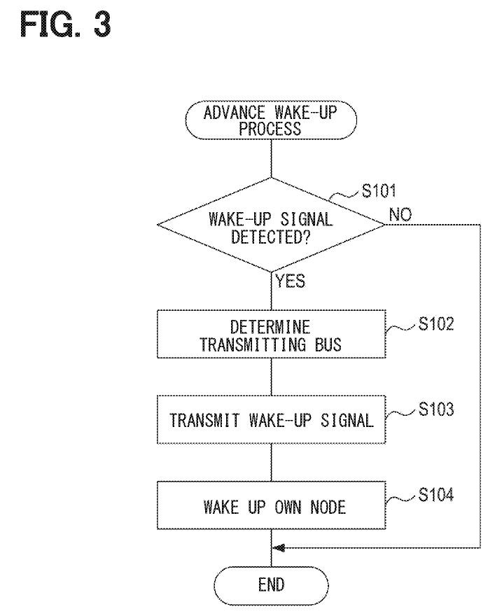

The advance wake-up processing executed by the central ECU 1 and/or the zone ECUs 2 to 4 will be described with reference to the flowchart shown in FIG. 3. In the execution of advance wake-up process, suppose that the vehicle is in parked state. When the vehicle is in parked state, the central ECU 1, the zone ECUs 2 to 4, and the terminal ECUs 5a to 5r are in sleep states.

### (1-2-1. Use Case 1)

This use case illustrates a case where a node belonging to the second layer executes the advance wake-up function.

For example, a case will be described in which the process is executed when a user uses the car finder service. Note that the car finder is a function of application that notifies the user of the location of vehicle in a parking lot in an easy-to-understand manner. Specifically, the car finder service is a function that notifies the user of the vehicle's location by flashing lights and activation of the horn. The car finder service also has the ability to automatically turn on the air conditioning and unlock the doors before the user gets into the vehicle.

As an example, suppose that the terminal ECU 5a is an ECU for controlling lights, the terminal ECU 5b is an ECU for controlling a horn, the terminal ECU 5d is an ECU for controlling an air conditioner, and the terminal ECU 5e is an ECU for controlling doors. The terminal ECUs 5a, 5b, 5d, and 5e are provided in the same zone.

The terminal ECUs 5a, 5b, 5d, and 5e and the zone ECU 2 are classified into the first group as nodes necessary for implementing the car finder service. First, the user issues an instruction to start the car finder service using a smartphone. When the cloud receives the instruction signal from the smartphone, the cloud transmits an event to the central ECU 1 instructing the execution of car finder service.

When the wireless communication unit 14 of central ECU 1 receives an event instructing execution of the car finder, the wireless communication unit 14 causes the central ECU 1 to transition to the wake-up state. Then, the NM control unit 13 of the central ECU 1 generates an NM frame. More specifically, the NM control unit 13 generates a second frame in which the bit position of the data field corresponding to the first group is set to "1".

Then, the central ECU 1 transmits an NM frame. The terminal ECUs 5a, 5b, 5d, 5e necessary for implementing the car finder service are nodes under the control of zone ECU 2, so the central ECU 1 transmits an NM frame to the communication line 6a.

In S101, the detection unit 23a of the second transceiver 23 included in the zone ECU 2 detects the NM frame transmitted as a wake-up signal from the central ECU 1 to the communication line 6a. In S102, the transfer unit 23c of the second transceiver 23 included in the zone ECU 2 determines the transmitting bus.

In S103, the zone ECU 2 transfers the wake-up signal. That is, in S102 and S103, the zone ECU 2 executes the routing process. When the receiving bus is previously set as the communication line 6a and the transmitting bus is previously set as the communication line 6d and the communication line 6e, the transfer unit 23c of the second transceiver 24 provided in the zone ECU 2 transfers the wake-up signal to the communication line 6d. Further, the transfer unit 23c of the second transceiver 25 included in the zone ECU 2 transfers the wake-up signal to the communication line 6e. More specifically, the transfer units 23c of the second transceivers 24 and 25 convert the protocol of received NM frame and transmit the converted frame as a wake-up signal to the communication lines 6d and 6e, respectively.

In S104, the activation unit 23b of the second transceiver 23 included in the zone ECU 2 switches own zone ECU 2 from the sleep state to the wake-up state. The routing process and the process of S104 are started almost simultaneously and executed in parallel. The zone ECU 2 actually transitions to the wake-up state after the routing process is completed.

The detection units 54a of the terminal ECUs 5a, 5b detect the NM frame transmitted to the communication line 6d as a wake-up signal. The detection units 54a of the terminal ECUs 5d, 5e detect the NM frame transmitted to the communication line 6e as a wake-up signal.

The activation unit 54b of each of the terminal ECUs 5a, 5b, 5d, and 5e controls own node to transition from the sleep state to the wake-up state. The terminal ECUs other than the terminal ECUs 5a, 5b, 5d, and 5e connected to the communication line 6d or communication line 6e (for example, terminal ECUs 5c and 5f) do not belong to the first group and therefore do not transition to the wake-up state. As described above, the second frame is generated by associating the bit position in the data field with a group, and a node transitions to a wake-up state only when the node receives a second frame that specifies the group to which own node belongs. When a terminal ECU does not have a function of processing an NM frame, the terminal ECU does not transition to the wake-up state.

The terminal ECU 5a controls the lights to flash, and the terminal ECU 5b controls the horn to output a sound. The terminal ECU 5d controls the air conditioner to be turned on, and the terminal ECU 5e controls the doors to be unlocked.

### (1-2-2. Use Case 2)

This use case illustrates another case where a node belonging to the second layer executes the advance wake-up function.

The following will describe a case where advance wake-up function is executed in providing of a monitoring service. The monitoring service is a function that automatically activates the camera and captures images a periphery area of the vehicle when the vehicle is collided in the parked state, such as a hit-and-run accident.

As an example, suppose that the terminal ECU 5k is an ECU connected to an impact sensor (not shown) that detects an impact applied to the vehicle, and the terminal ECU 5h is an ECU for controlling a camera equipped to the vehicle. The terminal ECUs 5h and 5k are provided in the same zone.

The terminal ECUs 5h and 5k and the zone ECU 3 are classified into the second group as nodes necessary for implementing the monitoring service. When the impact sensor detects an impact applied to the vehicle, the terminal ECU 5k transitions to the wake-up state.

Then, the NM control unit 53 of the terminal ECU 5k generates an NM frame. More specifically, the NM control unit 53 generates a second frame in which the bit position of the data field corresponding to the second group is set to "1".

Then, the terminal ECU 5k transmits the NM frame to the communication line 6g. In S101, the detection unit 23a of the second transceiver 25 included in the zone ECU 3 detects the NM frame transmitted as a wake-up signal to the communication line 6g.

In S102, the transfer unit 23c of the second transceiver 25 included in the zone ECU 3 determines the transmitting bus. In S103, the zone ECU 3 transfers a wake-up signal.

In other words, in S102 and S103, the zone ECU 3 executes the routing process. When the receiving bus is previously set as the communication line 6g and the transmitting bus is previously set as the communication line 6f, the transfer unit 23c of the second transceiver 24 provided in the zone ECU 3 transfers the wake-up signal to the communication line 6f.

In S104, the activation unit 23b of the second transceiver 25 included in the zone ECU 3 switches own zone ECU 3 from the sleep state to the wake-up state. The routing process and the process of S104 are started almost simultaneously and executed in parallel. The zone ECU 3 actually transitions to the wake-up state after the routing process is completed.

The detection unit 54a of the terminal ECU 5h detects the NM frame transmitted to the communication line 6f as a wake-up signal. Then, the activation unit 54b of the terminal ECU 5h switches the terminal ECU 5h from the sleep state to the wake-up state. The terminal ECUs other than the terminal ECU 5h connected to the communication line 6f do not belong to the second group, and therefore do not transition to the wake-up state. The terminal ECU 5h activates the camera and controls the camera to capture images of the periphery environment of the vehicle.

### (1-2-3. Use Case 3)

This use case describes a case where a node belonging to the first layer and a node belonging to the second layer execute the advance wake-up functions.

For example, a case will be described in which the advance wake-up process is executed when a user uses the key service. The key service is a door unlocking function when a user carrying a smart key approaches the vehicle.

As an example, suppose that the zone ECU 4 is an ECU for authenticating a smart key, and the terminal ECU 5e is an ECU for controlling a door. The terminal ECU 5e is provided in a lower layer which is under control of the zone ECU 2.

The terminal ECU 5e and the zone ECUs 2 and 4 are classified into the third group as nodes necessary for implementing the key service. When the user enters within a certain distance from the vehicle, the zone ECU 4 receives a signal indicating key information X transmitted from the smart key. Then, the zone ECU 4 transitions to the wake-up state.

The zone ECU 4 compares the key information X with the key information Y stored in the memory of the zone ECU 4 and determines whether the two pieces of information match with one another. When the matching is determined, the zone ECU 4 determines that the authentication is successful. When the two pieces of information do not match, the zone ECU 4 determines that the authentication is failed.

In response to determining that the authentication is successful, the NM control unit 22 of the zone ECU 4 generates an NM frame. More specifically, the NM control unit 22 generates a second frame in which the bit position of data field corresponding to the third group is set to "1".

Then, the zone ECU 4 transmits an NM frame. The terminal ECU 5e, which is necessary to implement the key service, is a node under the control of the zone ECU 2, and therefore the zone ECU 4 cannot directly transmit an NM frame to the terminal ECU 5e. The zone ECU 4 transmits the NM frame to the communication line 6c in order to transmit the NM frame to the terminal ECU 5e via the central ECU 1 and the zone ECU 2.

In S101, the detection unit 15a of the first transceiver 17 included in the central ECU 1 detects the NM frame transmitted as a wake-up signal from the zone ECU 4 to the communication line 6c. In S102, the transfer unit 15c of the first transceiver 17 included in the central ECU 1 determines the transmitting bus.

In S103, the central ECU 1 transfers the wake-up signal. That is, in S102 and S103, the central ECU 1 executes the routing process. When the receiving bus is previously set as the communication line 6c and the transmitting bus is previously set as the communication line 6a, the transfer unit 15c of the first transceiver 15 provided in the central ECU 1 transfers the wake-up signal to the communication line 6a.

In S104, the activation unit 15b of the first transceiver 17 included in the central ECU 1 switches the central ECU 1 from the sleep state to the wake-up state. The routing process and the process of S104 are started almost simultaneously and executed in parallel. The central ECU 1 actually transitions to the wake-up state after the routing process is completed.

The detection unit 23a of the second transceiver 23 included in the zone ECU 2 detects the NM frame transmitted as a wake-up signal from the central ECU 1 to the communication line 6a. The subsequent processing by the zone ECU 2 is similar to the above-described use case 1. For example, when the receiving bus is previously set as the communication line 6a and the transmitting bus is previously set as the communication line 6d and the communication line 6e, the transfer unit 23c of the second transceiver 24 provided in the zone ECU 2 transfers the wake-up signal to the communication line 6d. The transfer unit 23c of the second transceiver 25 included in the zone ECU 2 transfers the wake-up signal to the communication line 6e. More specifically, the transfer units 23c of the second transceivers 24 and 25 convert the protocol of received NM frame and transmit the converted frame as a wake-up signal to the communication lines 6d and 6e, respectively.

The activation unit 23b of the second transceiver 23 included in the zone ECU 2 switches the zone ECU 2 from the sleep state to the wake-up state. The zone ECU 2 actually transitions to the wake-up state after the routing process is completed.

The detection unit 54a of the terminal ECU 5e detects the NM frame transmitted to the communication line 6e as a wake-up signal. Then, the activation unit 54b of the terminal ECU 5e switches own node from the sleep state to the wake-up state. The terminal ECUs other than the terminal ECU 5e connected to the communication line 6d or 6e do not belong to the third group, and therefore do not transition to the wake-up state. The terminal ECU 5e controls the door to be unlocked.

### (1-3. Technical Effects)

According to the above-described embodiment, the following effects can be obtained.

(1a) When a wake-up signal is detected by the detection unit 15a, 23a, the transfer unit 15c, 23c is configured to transfer the wake-up signal to a communication line different from the communication line on which the wake-up signal is detected while maintaining the sleep state. That is, the central ECU 1 and the zone ECUs 2 to 4 each has an advance wake-up function.

Suppose that the central ECU 1 and the zone ECUs 2 to 4 do not have the advance wake-up function. For example, as described in use case 1, when nodes transition to the wake-up state in order from the first layer to the third layer, a node belonging to the first layer transmits a wake-up signal to a node belonging to the second layer after the node has completed the transition to the wake-up state. After the nodes in the second layer have completed transition to the wake-up state, they transmit a wake-up signal to the nodes in the third layer. As a result, it takes a long time for all of the nodes connected in the hierarchy structure to transition to the wake-up state. That is, a total sum of a first time necessary for nodes belonging to the first hierarchical layer to transition to the wake-up state, a second time necessary for nodes belonging to the second hierarchical layer to transition to the wake-up state, and a third time necessary for nodes belonging to the third hierarchical layer to transition to the wake-up state, is necessary for the nodes included in all of the layers transition to the wake-up state.

According to the above-described configuration of the present disclosure, before the nodes belonging to the second layer transition to the wake-up states, the wake-up signal is transmitted to the nodes belonging to the third layer. That is, while the nodes belonging to the second layer are transitioning to the wake-up states, the nodes belonging to the third layer are also transitioning to the wake-up states. Therefore, the time required for nodes in all layers to transition to the wake-up state can be shortened. Therefore, in the communication system 100 in which multiple nodes are connected in a hierarchical structure, it is possible to prevent an increase in the time required for the multiple nodes to wake up sequentially in each layer.

(1b) The NM frame includes the wake-up signal. With this configuration, an existing frame can be used as the wake-up signal. Therefore, there is no need to provide a dedicated communication line to implement the advance wake-up function.

(1c) The transfer units 15c and 23c transmit the wake-up signal to the predetermined communication lines in accordance with the communication line on which the wake-up signal is received. With this configuration, the processing is determined in advance, so the transfer units 15c and 23c can transmit the wake-up signal quickly, compared to a configuration in which the contents of frame is identified and determination is made as to which communication line the wake-up signal should be transmitted.

(1d) When the detection unit 15a or 23a detects the wake-up signal, the activation unit 15b or 23b switches own node to the wake-up state, and the transfer unit 15c or 23c transmits the wake-up signal. At this time, before the transition of own node to the wake-up state is completed, the transfer unit 15c or 23c transmits the wake-up signal. Herein, the transition of own node is executed by the activation unit 15b or 23b. With this configuration, the wake-up signal is transmitted by the transfer units 15c, 23c while the node is transitioning to the wake-up state, and therefore the wake-up signal can be transmitted more quickly than in a configuration in which the wake-up signal is transmitted after the node has completed the transition to the wake-up state.

(1e) The communication system 100 includes the central ECU 1, the multiple zone ECUs 2 to 4, and the multiple terminal ECUs 5a to 5r, and is configured in multiple layers. When the number of layers is increased, the transfer times of NM frames is increased. Thus, the time required for the nodes in all layers to transition to the wake-up state tends to be increased. However, the central ECU 1 and the zone ECUs 2 to 4 each has the advance wake-up function, and therefore can transfer the NM frame with a higher speed. Therefore, even when the number of layers increases, it is possible to prevent an increase in the time required for nodes in all layers to transition to the wake-up state.

### 1-4. Correspondence

In the above embodiment, the central ECU 1 corresponds to a first communication device, the multiple zone ECUs 2 to 4 correspond to multiple second communication devices, and the terminal ECUs 5a to 5r correspond to multiple third communication devices.

### 2. Other Embodiments

Although the embodiments of the present disclosure are described above, it is needless to say that the present disclosure is not limited to the above-described embodiments and that various configurations can be adopted.

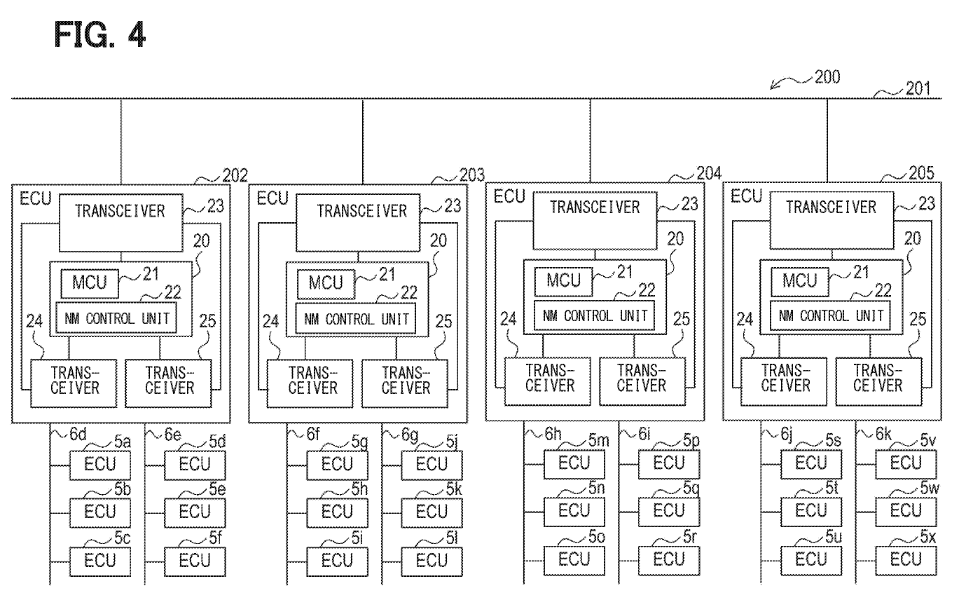

(2a) In the above embodiment, the communication system 100 includes the central ECU 1, the multiple zone ECUs 2 to 4, and the multiple terminal ECUs 5a to 5r, which are connected in three hierarchical layers. The connection topology of nodes that configure the communication system is not limited to this example. As another example, a communication system 200 according to a first modification is shown in FIG. 4. The communication system 200 may include multiple domain controllers 202 to 205 and multiple terminal ECUs 5a to 5x. The same reference symbol as in the first embodiment denote the same element, and reference is made to the preceding description of above-described embodiment.

The multiple domain controllers 202 to 205 are connected by a communication line 201 so as to be able to transmit and receive data. Each of the domain controllers 202 to 205 is connected to one or more of the multiple terminal ECUs 5a to 5x via one of the communication lines 6d to 6k so as to be able to transmit and receive data.

The domain controllers 202 to 205 are communication devices that can control the operations of terminal ECUs 5a to 5x connected to the domain controllers 202 to 205. Furthermore, the domain controller 204 may be configured to control other domain controllers 202, 203, and 205, thereby achieving coordinated control of the entire vehicle.

Similar to the zone ECUs 2 to 4, the domain controllers 202 to 205 each includes an MCU 21 and second transceivers 23 to 25. That is, the domain controllers 202 to 205 each has the advance wake-up function. Furthermore, the domain controllers 202 to 205 each implements the function of NM control unit 22 by executing the program stored in the memory using the CPU.

Similar to the multiple terminal ECUs 5a to 5r, the multiple terminal ECUs 5s to 5x each include a CPU 51, a memory 52, and a third transceiver 54. The terminal ECUs 5s to 5x each implements the function of NM control unit 53 by executing the program in the memory 52 using the CPU 51.

The above-described first modification also achieves the effects (1a) to (1d) of the above-described embodiment.

In the above-described first modification, the domain controller 204 corresponds to a first communication device, the domain controllers 202, 203, and 205 correspond to multiple second communication devices, and the terminal ECUs 5a to 5x correspond to multiple third communication devices.

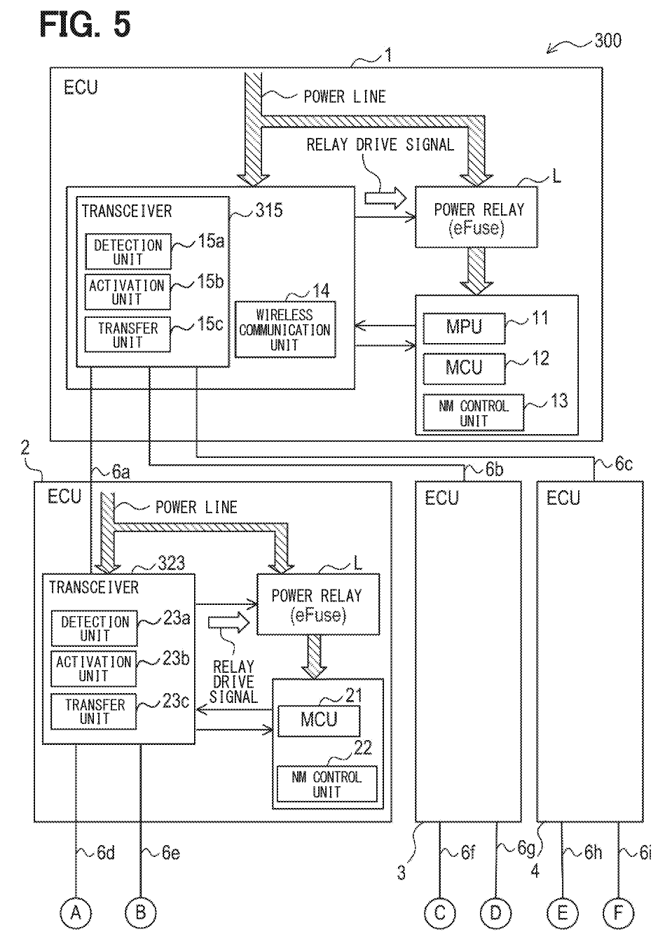

(2b) In the above embodiment, the central ECU 1 includes the first transceivers 15 to 17, and the zone ECUs 2 to 4 each includes the second transceivers 23 to 25. A communication system 300 according to a second modification is shown in FIG. 5. The functions of first transceivers 15 to 17 may be integrated into a single first transceiver 315. The first transceiver 315 may be provided by a single transceiver module. The first transceiver 315 may include respective communication ports for connecting to the multiple communication lines 6a to 6c.

The functions of second transceivers 23 to 25 may be integrated into a single second transceiver 323. The second transceiver 323 may be provided by a single transceiver module. The configuration of zone ECUs 3 and 4 is not shown, but is similar to that of the zone ECU 2. The second transceiver 323 of the zone ECU 2 may have communication ports connected to the communication lines 6a, 6d, and 6e, respectively. The second transceiver 323 of the zone ECU 3 may have communication ports connected to the communication lines 6b, 6f, and 6g, respectively. The second transceiver 323 of the zone ECU 4 may have communication ports connected to the communication lines 6c, 6h, and 6i, respectively.

In the central ECU 1, a well-known semiconductor fuse (hereinafter referred to as eFuse) that connects/disconnects the power line (that is, turns on/off the power supply from a not-shown battery) may be arranged in the path (for example, the power line) that supplies power to the MPU 11 and the MCU 12. Hereinafter, a device that connects or disconnects a power line, such as the eFuse 31a, may be referred to as a power relay L.

A power line is connected between the first transceiver 315 and the power relay L, and power is constantly supplied to the first transceiver 315. The MPU 11 and MCU 12 can be supplied with power via the power relay L. When the detection unit 15a detects the wake-up signal, the activation unit 15b outputs a relay drive signal to the power relay L to turn on the power relay L. As a result, power supply to the MPU 11 and MCU 12 is restarted.

A power line is connected between the second transceiver 323 and the power relay L, and power is constantly supplied to the second transceiver 323. The MCU 21 can be supplied with power via the power relay L. When the detection unit 23a detects the wake-up signal, the activation unit 23b outputs a relay drive signal to the power relay L to turn on the power relay L. As a result, power supply to the MCU 21 is restarted.

The terminal ECUs 5a to 5r each may also be configured to include a power relay L. More specifically, a power line is connected between the third transceiver 54 and the power relay L, and power is constantly supplied to the third transceiver 54. The CPU 51 can be supplied with power via the power relay L. When the detection unit 54a detects the wake-up signal, the activation unit 54b outputs a relay drive signal to the power relay L to turn on the power relay L. As a result, power supply to the CPU 51 is restarted. The domain controllers 202 to 205 of the first modification example may also have the same configuration as the zone ECU 2 of the second modification example.

(2c) In the above embodiment, the central ECU 1, the zone ECUs 2 to 4, and the terminal ECUs 5a to 5r each is configured to include the NM control unit 13, 22, 53 that generates the NM frame. Alternatively, some nodes may be configured to not include the NM control unit. In the present modification, only the node that is likely to wake up first is equipped with the NM control unit, and nodes other than the node that is likely to wake up first may not be equipped with an NM control unit. In the present modification, when the node that wakes up first generates and transmits an NM frame, the other nodes simply forward the NM frame, and therefore there is no need for the other nodes to generate an NM frame. For example, in the use case 1, only the central ECU 1 that wakes up first may be equipped with an NM control unit.

In the above embodiment, the first transceivers 15 to 17, the second transceivers 23 to 25, and the third transceiver 54 are configured to be capable of processing the NM frames. Alternatively, some nodes may be configured to without capability of processing the NM frames. In the present modification, nodes that do not belong to any group do not need to wake up in response to an NM frame, and therefore their transceivers do not need to have the function of processing NM frames.

(2d) The multiple functions of one element in the above embodiment may be implemented by multiple components, or a function of one component may be implemented by multiple components. In addition, multiple functions of multiple components may be implemented by one component, or a single function implemented by multiple components may be implemented by one component. In the above embodiment, a part of the configuration may be properly omitted. At least a part of the configuration of the above embodiment may be added to or substituted for the configuration of the other embodiment.

(2e) In addition to the communication systems 100, 200, and 300 described above, the present disclosure can also be implemented in various forms, such as individual devices that are components of the communication systems 100, 200, and 300, and the method of advance wake-up processing.

What is claimed is:

1. A communication system comprising:
a first communication device;
one or more second communication devices connected to a communication line to directly communicate with the first communication device; and
one or more third communication devices connected to a communication line to directly communicate with the first communication device or the one or more second communication devices,
wherein
the first communication device includes a first transceiver,
the one or more second communication devices include a second transceiver,
the one or more third communication devices include a third transceiver,
each of the communication devices has a wake-up state, which is a normal operating state, and a sleep state, which is a low-power operating state in which a power consumption is lowered compared with the normal operating state by partially or completely restricting functions other than a function of transceiver,
each of the first transceiver, the second transceiver, and the third transceiver includes:
a detection unit configured to detect a wake-up signal, which is a signal instructing the corresponding communication device to transition to the wake-up state; and
an activation unit configured to activate the corresponding communication device from the sleep state to the wake-up state when the wake-up signal is detected by the detection unit, and
the first transceiver and/or the second transceiver includes a transfer unit configured to transmit, in response to the detection unit detecting the wake-up signal, the wake-up signal to one of the communication lines different from the communication line on which the wake-up signal is detected while maintaining the sleep state of the corresponding communication device.

2. The communication system according to claim 1, wherein
each of the first transceiver, the second transceiver, and the third transceiver is configured to process a network management frame, which is a frame for managing a state of the communication system, and
the network management frame includes the wake-up signal.

3. The communication system according to claim 1, wherein
the transfer unit transmits the wake-up signal to the communication line, which is defined in advance corresponding to the communication line from which the wake-up signal is received.

4. The communication system according to claim 1, wherein,
in the first communication device and/or the one or more second communication devices, in response to the detection unit detecting the wake-up signal, the activation unit activates the corresponding communication device to the wake-up state and the transfer unit transfers the wake-up signal, and
the transfer of the wake-up signal by the transfer unit is executed before a completion of activation to the wake-up state by the activation unit.

5. The communication system according to claim 1, wherein
the first communication device is configured to control the one or more second communication devices to implement a coordinated control of the communication system,
an area in which the communication system is installed is divided into multiple zones and the one or more second communication devices are provided for each of the multiple zones,
each of the one or more second communication devices is configured to control the one or more third communication devices provided in the same zone, and
the one or more third communication devices are connected to the communication line to directly communicate with one of the one or more second communication devices.
